(19) United States
(12) Patent Application Publication
(10) Pub. No.: US 2006/0123089 A1
(43) Pub. Date: Jun. 8, 2006

(54) Formulating and sending a message by a personal messaging device

(76) Inventors: Janet E. Cahn, Arlington Heights, IL (US); Steven W. Albrecht, Glenview, IL (US); Kenneth W. Douros, South Barrington, IL (US); Noel S. Massey, Carpentersville, IL (US)

Correspondence Address: MOTOROLA, INC., 1303 EAST ALGONQUIN ROAD, IL01/3RD, SCHAUMBURG, IL, 60196, US

(21) Appl. No.: 11/004,739

(22) Filed: Dec. 3, 2004

(51) Int. Cl. G06F 15/16

(52) U.S. Cl. 709/206

(57) ABSTRACT

Means and method are for sending a wireless message (620) by a personal messaging device (2000) using a message template (305, 400, 500) that is formed by user input. A static component (405), dynamic component (410, 510), and trigger condition (415) of a message template are specified by user input and stored in the personal messaging device. When satisfied, the trigger condition causes one or more wireless messages to be transmitted using the message template. The dynamic component of the message template may include a set of dynamic information (411) obtained from a set of information sources at the occurrence of one or more dynamic events. The one or more dynamic events (412, 512) may be the same as the trigger condition.

### FIELD OF THE INVENTION

The technology of this invention is generally in the area of wireless communication systems, and more specifically is in the area of user formulation of messages in personal messaging devices.

### BACKGROUND

Wireless messages in conventional personal messaging devices are composed and transmitted using a variety of techniques. For example, a user may compose a text message using a keyboard and press a send key to initiate an encoding and transmission of the text message. In another example, the user may select a stored text phrase or sentence that the user can then edit and cause to be transmitted. In another example, the user may craft a text message by one of the means described and append an attachment to it, such as a sound bite, or a picture, or a short video clip. However, there are some situations for which messages cannot conveniently be composed and sent using conventional personal messaging techniques. For example, a user might benefit by a message that is sent every ten minutes that indicates an estimated distance of the user from a selected location, along with some fixed text information, such as “at 10:15 AM I am 13 miles from the church” while the user is driving. This can present challenges when conventional personal messaging devices are used.

### BRIEF DESCRIPTION OF THE DRAWINGS

The present invention is illustrated by way of example and not limitation in the accompanying figures, in which like references indicate similar elements, and in which:

FIG. 1 is a flow chart shows some steps of a method for formulating and sending a message in accordance with some embodiments of the present invention;

FIG. 2 is a flow chart that shows some steps for specifying by user input a dynamic component of a message template, in accordance with some embodiments of the present invention;

FIG. 3 is a block diagram that show a portion of memory in a personal messaging device, in accordance with some embodiments of the present invention;

FIGS. 4 and 5 are block diagrams that show a message template structure in the personal messaging device, in accordance with some embodiments of the present invention;

FIG. 6 is a block diagram that shows the formation of a wireless message, in accordance with some embodiments of the present invention;

FIGS. 7-19 are a series of display images that are presented on a display of the personal messaging device, in accordance with an example of some embodiments of the present invention; and

FIG. 20 is an electrical block diagram of a personal messaging device, in accordance with some embodiments of the present invention

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular method and personal messaging device for sending messages in accordance with the present invention, it should be observed that the present invention resides primarily in combinations of method steps and apparatus components related to personal messaging devices. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without specific constraints, preclude the existence of additional identical elements in the process, method, article, or apparatus that comprises the element.

A “set” as used in this document, means a non-empty set (i.e., comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

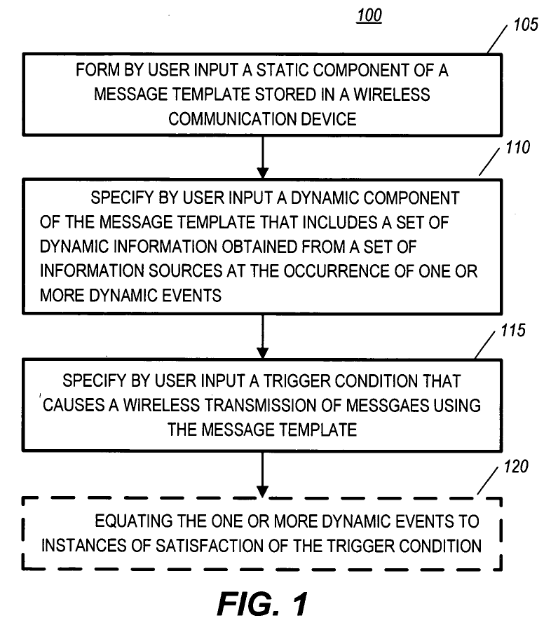

Referring to FIG. 1, a flow chart 100 shows some steps of a method for sending a message in accordance with some embodiments of the present invention. A user of a personal messaging device may form a static component of message template at step 105. The system in which the personal messaging device is used may, for example, a satellite system, a wide area network, local area network, or personal area network. The personal messaging device may be any device that is commonly used for personal messaging, such as a cellular telephone, a text pager, a remote telephone, a vehicular messaging terminal, or any like device that a user can operate to send messages including any type of information, such as text, voice, graphics, picture, video, audio, texture, taste, smell, biometric, location, or orientation information, or any combination thereof. Personal messaging devices typically include a capability to capture and send verbal messages, such as real time voice messages and/or text messages composed by a user for essentially immediate transmission. The verbal messages may often be in response to received verbal messages In the context of this document, location information may include position, velocity, and derivatives thereof, and orientation may include such orientation metrics as pitch, roll and yaw. The static component of the message is a component that is defined by the user upon forming of the static component and that does not change before the message is transmitted. Examples of static components are any text character arrangements ranging from one character to a set of text documents that may include graphics, or a voice or sound segment that may be transmitted by analog or digital or compressed digital means, or a picture or a video segment, or a smell or taste that is sensed and captured, or any combination of these when the static component is formed. The static information may be from any source or combination of sources from which the information is available at the time the user forms the static information. For example, the information source may be the user, or it may be the messaging device, such as a clock that generates a current time of day, or a camera that captures a picture. The information source may alternatively be an external information source—that is, a source external to the personal messaging device. For example, the information source may be another wireless message device, or it may be a separate music playing device that can download a song to the personal messaging device by cable, or an external Global Positiioning System, just to list a few. More typically, the static information is text generated by the user.

The user of the personal messaging device may also form a dynamic component of the message template at step 110. The dynamic component may include a set of dynamic information that is obtained from a set of information sources at the occurrence of one or more dynamic events.

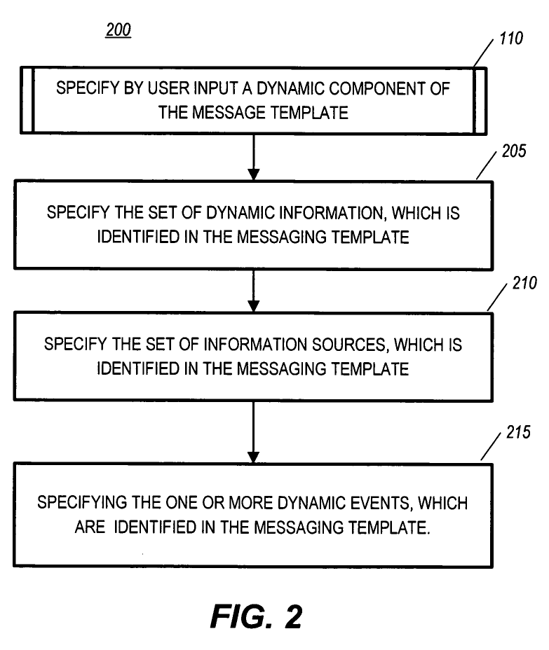

Referring to FIG. 2, a flow chart 200 shows some further details of step 110, specifying by user input a dynamic component of the message template, in accordance with some embodiments of the present invention. At step 205, the user may specify the set of dynamic information, which is identified in the message template. The set of dynamic information may include any of the types of information described above with reference to the static information, however the set of dynamic information is not captured at the time the user specifies the type of information to be captured, but is captured at the occurrence of one or more dynamic events. Thus, the information content of the set of dynamic information that is to be transmitted is not typically available at the time the set of dynamic information is specified in the message template.

At step 210, the user may specify the set of information sources, which is identified in the message template. The set of dynamic information may be obtained from the types of information sources described above with reference to the static information, but should exclude information obtained by user entry. This does not mean that the dynamic information cannot be about the user (e.g., a picture of the user, a most recent audio clip that includes the user's voice, or a biometric of the user sensed by the personal messaging device), but that the user does not enter dynamic information into the personal messaging device.

In some embodiments, it may not be necessary for the user to specify the set of dynamic information; for example, there may be only one type of dynamic information that is usable in a particular message template and the user must specify one or more sources that can supply the desired type of dynamic information. In other embodiments, it may not be necessary to obtain a set of information sources from the user; the sources could be inferred from the specification of the set of dynamic information, or there could, for example, be only one source that generates a plurality of information types from which the user specifies one or more. Thus, the user may specify either or both of the set of dynamic information and the set of information sources when specifying the dynamic component.

At step 215, the user may specify the one or more dynamic events, which are identified in the message template. The dynamic event may be any type of non-continuous event that can be sensed or determined by the personal messaging device, and may be generated by such sources as a button, or other inputs that a satisfy a specified relationship, such as a sensed audio pattern, an orientation change, a sensor input, a location or proximity determination, a specified time, or a specified incoming message. A “sensed audio pattern” is meant to include such things as a sensed voice command, the detection of clapping, or the sensing of a background noise level. Sensor inputs include, but are not limited to, humidity, water, temperature, smell, taste, and biometrics sensor signals. A button push may be, for example, the depression of a “Send” button, or the change of state of a power button. Time may be a single specified time or a plurality of times specified, for example, by a starting time and an interval. It will be appreciated that the sources of the dynamic events may be considered to be among the information sources of the personal messaging device, since the dynamic event could also be conveyed as a part of the set of dynamic information.

Referring again to FIG. 1, the user may specify a trigger condition at step 115 that causes a wireless transmission of messages using the message template when the trigger condition is satisfied. The trigger condition may be specified as the receipt of a particular value (a target value) of information from one information source (such as one of those described above with reference to static or dynamic information) or a particular relationship of information from the set of information sources. Thus, the trigger condition can include actions of the user, such as activating a send button. In this instance, the message is sent by action of the user, but may include dynamically determined information that the user does not need to compose. The information sources for the trigger condition may be called the trigger information sources.

In some embodiments, the dynamic event or events that identify when the set of dynamic information is captured may be defined at optional step 120 to be the same as the events or instances that satisfy the trigger condition, so that the specification of the trigger condition is also a specification of the one or more dynamic events. In these embodiments, it may not be necessary to provide the user an opportunity to specify any dynamic events, only the set of dynamic information. The equating done at step 120 may be invoked by a user selectable option, may be a default mode of operation of the personal messaging device, or may be controlled by a system operator of a system to which the personal messaging device is assigned.

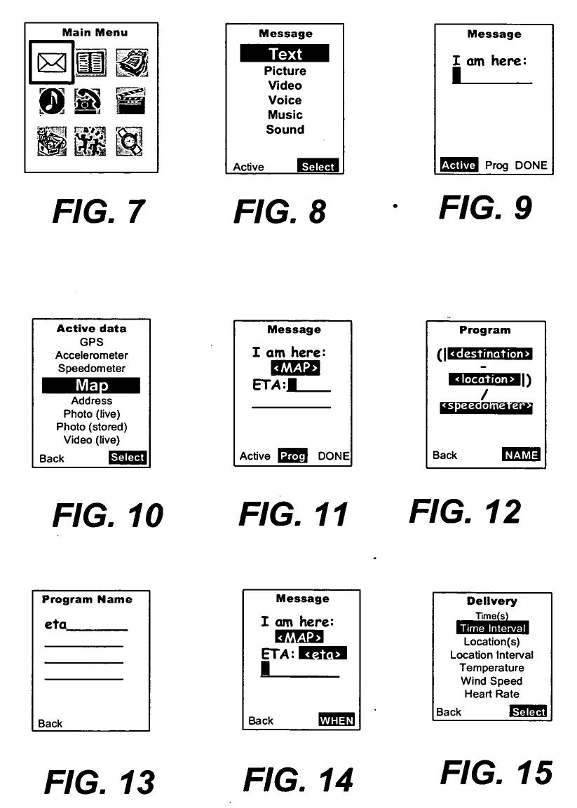

It will be appreciated that the functions described by steps 105 to 115 comprise the entry of information in to the personal communication device. This entry of information may be done consecutively or may be interspersed, in order to make the entry of the information easy for the user (“human friendly”). In other words, portions of any of steps 105-115 (FIG. 1) as well as steps 205-215 (FIG. 2) may be completed in different orders to make the entry easy for the user or to obtain antecedent information that is a part of a later step. An example of interspersed entry is given below with reference to the description of FIGS. 7-19.

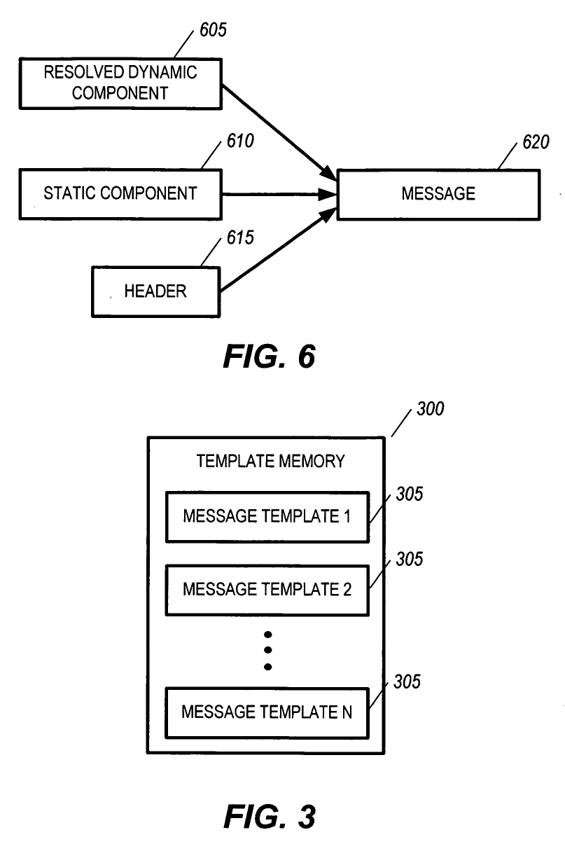

Referring to FIG. 3, a block diagram shows a portion of memory 300 in the personal messaging device, in accordance with some embodiments of the present invention. The portion of memory 300 stores message templates 305 for N messages, which may simultaneously be in the process of formulation according to the N templates.

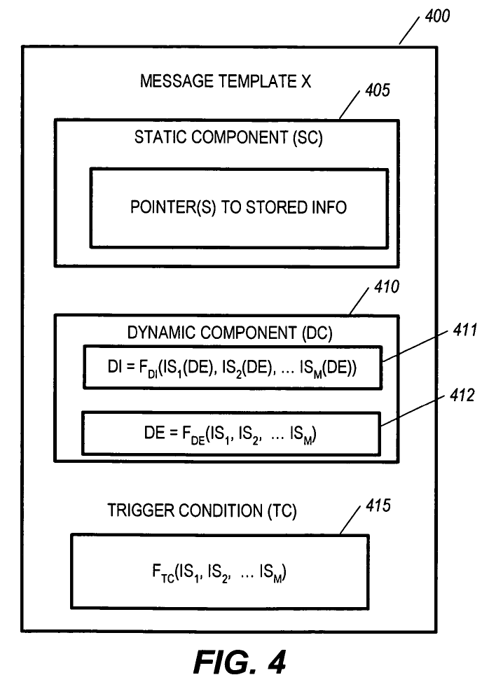

Referring to FIG. 4, a block diagram shows a message template structure 400 in the personal messaging device, in accordance with some embodiments of the present invention. The message template structure 400 is for message template X and comprises a static component (SC) 405, a dynamic component (DC) 410, and trigger condition (TC) 415. The static component 405 stores one or more pointers to static information that has been stored within the personal messaging terminal. The user has interacted with the messaging terminal to identify the static information, as described above with reference to FIG. 1.

The dynamic component 410 includes identification of a set of dynamic information (DI) 411 and identification of one or more dynamic events (DE) 412. The one or more dynamic events 412 occur as specified by the user in the message template, based on information that is obtained from a plurality of M information sources (ISₓ) available to the messaging unit, as described herein above with reference to FIGS. 1 and 2. As described above, a dynamic event may be, for example, a time or time interval, or receipt of some specific information. However, not all of the available information sources are necessarily used when a particular message template has been specified by the user. Thus the one or more dynamic events 412 are expressed as DE=F_{DE} (IS₁, IS₂, . . . IS_{M}), wherein some of the IS_{X} may not be used. A dynamic event may require simultaneous occurrence of information from two or more sources IS_{X}. For example, a dynamic event may occur upon a button push only when some other information is in a particular state. Any of the IS_{X} may be interpreted to represent a particular type of information from an information source for those embodiments in which more than one type of information is available from one information source. As one example, two IS_{X} may represent one physical source, but two different types of information. In some embodiments of the present invention, or for some information sources (e.g., current time), an information source and the information type may be synonymous. As one example, a button may be an information source and the activation of the button may be the only information from that source, making them essentially synonymous. (The button may also be an event generator).

The one or more dynamic events 412 determine when the information in the set of dynamic information 411 is obtained, and the information may be obtained by combining information from any number of the available information sources ISₓ in any logical manner, so the set of dynamic information 411 is expressed as DI=F_{DI}(IS₁(DE), IS₂(DE), . . . , IS_{M}(DE)), wherein some of these factors may be null.

The trigger condition 415 is, like the one or more dynamic events, determined form the set of information sources, and is therefore expressed for this example by TC=F_{TC}(IS₁, IS₂, . . . IS_{M}). However, in accordance with some embodiments of the present invention being described with reference to FIG. 4, the trigger condition is not the same as the conditions for which the one or more dynamic events are generated.

Referring to FIG. 5, a block diagram shows a message template structure 500 in the personal messaging device, in accordance with some embodiments of the present invention. The message template structure 400 is for message template X and comprises a static component (SC) 405, a dynamic component (DC) 510, and trigger condition (TC) 415. In these embodiments, the one or more dynamic events are the same as the trigger condition, but the rest of message template formation is the same as described with reference to FIG. 4. The user may be able to choose or set DE=TC in some embodiments.

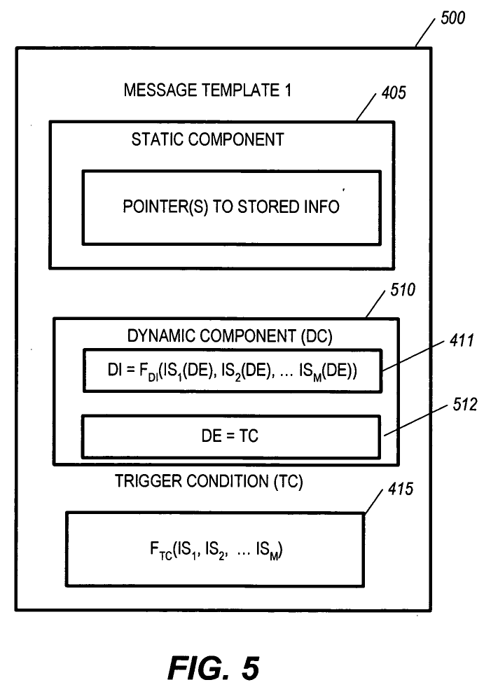

Referring to FIG. 6, a block diagram shows the formation of a wireless message 620, in accordance with some embodiments of the present invention. When a trigger condition occurs, a resolved dynamic component 605 is formed by determining any of the set of dynamic information, if any, that is formed by a dynamic event that is equivalent to the trigger condition. Dynamic information formed from other information or events will have been determined earlier. The resolved dynamic information 605 is combined with the static component 610 that was formed when the message template was specified by the user, and appropriate message header information 615 is added to form the message 620. Other types of information (e.g., non-template information) could be added that is ready for transmission. The message 320 can then be encoded, modulated and transmitted.

Referring to FIGS. 7-19 a series of display images that are presented on a display of the personal messaging device are shown, in accordance with an example of some embodiments of the present invention. The user is presented with a set of icons representing a portion of available applications, from which the user selects the envelope, which identifies an email application. In FIG. 8, a presentation of a list of some types of static messages is shown, from which the user has selected “Text”. The user is presented with an image which can be used to enter text. The user enters “I am here:” on one line and then after the user sets the cursor at the beginning of the next line (FIG. 9), the user changes from a “Select” mode (at the bottom of the image) to the “Active” mode, which causes the personal messaging device to present the user with an “Active Data” screen image (FIG. 10). “Active Data” is the phrase used to indicate types of dynamic information from which the user can select. In this example, some types of dynamic messages that are available for selection are presented. The user selects “Map”, and the personal messaging device then displays “<Map>”, as shown in FIG. 11, indicating that a Map will be inserted into the transmitted message. In this example, when the user selects “Map”, a local map is inserted by default. In other embodiments, the user might select a map for a different region instead.

The user then enters some additional text “ETA:”, which is additional static text, and then elects to go into a Program mode, as shown at the bottom of the image in FIG. 11. “ETA” stands for “estimated time of arrival” in this example. In the Program mode, the user enters information types that are available from sources to which the wireless device has access, in a functional form that defines how to manipulate the information in order to generate part of the set of dynamic information. This operation is encompassed by the more general expression given for the set of dynamic information 411 in FIGS. 4 and 5 as DI=F_{DI}(IS₁(DE), IS₂(DE), . . . , IS_{M}(DE)). In the particular example being described, the user expresses a function to determine a value to include after “ETA:”. The function is: information value <destination> minus information value <location> divided by information value <speedometer>. These information values are either selected from a list of available information values or the names are known to the user and typed into the program. When the program for the function is complete, the user selects “NAME” at the bottom of the screen image, and the personal messaging device presents an image that the user uses to enter “eta” as the name of the program (FIG. 13). The user then selects “back” and enters the program name “eta” after “ETA:” to invoke the function defined by the program (i.e., store it within the message template). Alternatively, this program may have been created some time previously by the user or another person and could then be selected or entered by the user after “ETA:”, thereby avoiding the entry described with reference to FIG. 12. In this example, a mode “WHEN” is presented in addition to “Back” to the user after the entry of function “<eta>” (which the personal messaging device has determined to be an acceptable function). These selections allow the user to either continue generating additional dynamic information (“Back”) or to go into a mode to define the dynamic event and trigger condition for this dynamic information to be resolved and for the message to be sent. In this example, both actions have been defined to be synonymous, although as explained above, they need not be.

The user selects “WHEN” and the personal messaging device presents a “Delivery” image to the user, which shows a partial list of possible trigger conditions/dynamic events (FIG. 15). In this example, the user selects “time interval” and is with a “Time Interval” image, from which the user can set a time interval. The user enters “5” and selects “minutes”, thus electing to trigger transmission every 5 minutes of the user estimate time of arrival as calculated from dynamic information available to the personal messaging device, without the user's intervention for each transmission. The user then selects “TO” at the bottom of the image and the personal messaging device presents a “recipient” image to the user, which shows a portion of a list of possible predetermined recipients (FIG. 17). The user selects two recipients and then indicates completion of the selection of recipients by selecting “DONE” at the bottom of the image. The personal messaging device then presents a “Send” image in which the entire message template is summarized for verification. The user in this example selects “CONFIRM” (FIG. 18) and the personal messaging device stores the message template and presents the user with a “Message Stored” screen.

The storage of the message initiates the interval timer, sending a message every 5 minutes indicating an estimated time of arrival for the user without the user having to estimate the ETA and generate the series of messages individually. It should be appreciated that in several instances, the figures show a portion of a list. In such instances (FIGS. 8, 10, 15, 16, and 17) the lists may be a complete list or a portion of a list the entirety of which can be viewed by the user by causing the list to scroll up and down or to page.

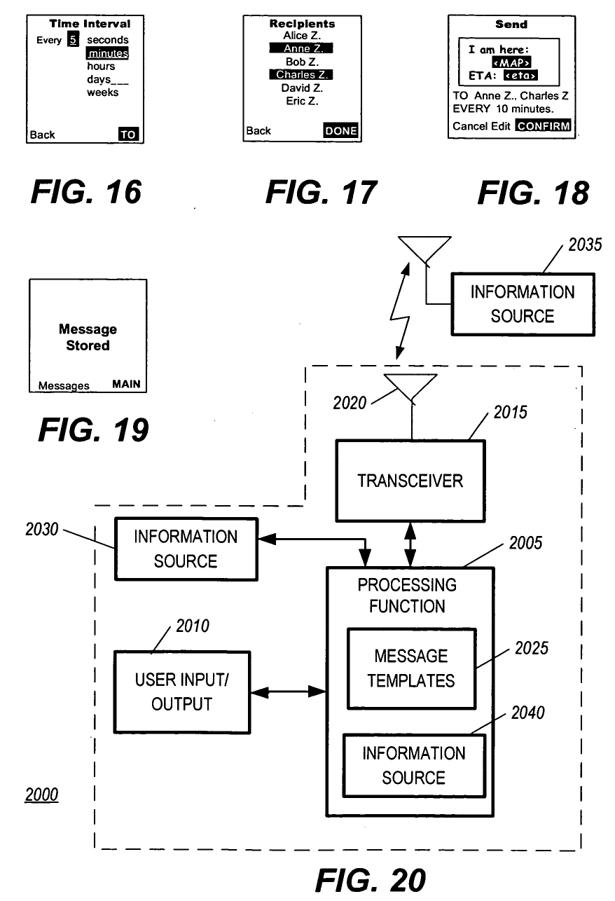

Referring to FIG. 20, an electrical block diagram of a personal messaging device 2000 is shown, in accordance with some embodiments of the present invention. The personal messaging device 2000 comprises a processing function 2005, user input/output functions 2010, a transceiver 2015, a radiating/receiving device 2020, and two information sources—information source 2030 and information source 2040. The user input/output functions 2010 may comprise any user input device or devices such as a keyboard, a microphone for voice audio that is voice recognized, a camera for recognizing gestures, and any user output device or devices such as a display and a speaker. The signals to and from the user input/output devices are coupled to the processing function 2005. The processing function includes storage 2025 for message templates as described herein above. The processing function is further coupled to a transceiver 2015 that accepts encoded messages formed according to one of the message templates stored in the storage 2025, modulates them and transmits them using the radiating/receiving device 2020, to which the transceiver 2015 is coupled. The transceiver 2015 includes a transmitter and receiver. The transceiver 2015 and radiating/receiving device 2020 may operate using radio frequency or light as a medium. The processing function 2005 can interact with a user to accept user input, via the user input/output, that 1) forms a static component of a message template stored in the personal messaging device, 2) specifies a dynamic component of the message template that includes a set of dynamic information obtained from a set of information sources at the occurrence of one or more dynamic events, and 3) specifies a trigger condition that when satisfied causes one or more wireless messages to be transmitted using the message template. The set of information sources may include an information source 2030 which is an internal information source such as a built in microphone. The set of information sources may include an information source 2040 which is an internal information source within the processing function, such as a memory capacity monitor. The set of information sources may include information source 2035 which is an external information source, such as a fixed network transmitter or a radio frequency transmitting door alarm. An external alarm could also be connected by wires to the personal messaging device (not shown in FIG. 20). The wireless transmitter of the transceiver 2015 transmits the one or more wireless messages.

It will be appreciated the processing function 2005 of the personal messaging device 2020 described herein may be comprised of one or more conventional processors and unique stored program instructions that control the one or more processors to implement, in conjunction with certain non-processor circuits, some, most, or all of the functions of the processing function described herein. The non-processor circuits may include, such items as, a radio receiver, a radio transmitter, signal drivers, clock circuits, power source circuits, and user input devices. As such, these functions may be interpreted as steps of a method to perform accessing of a communication system. Alternatively, some or all functions could be implemented by a state machine that has no stored program instructions, in which each function or some combinations of certain of the functions are implemented as custom logic. Of course, a combination of the two approaches could be used. Thus, some methods and means for these functions have been described herein.

Thus, a convenient means and method have been described for transmitting a wireless message from a personal messaging device that has been formed by a user generated template. A user generated template that includes a dynamic component as described herein uniquely allows the transmission of messages automatically, freeing the user from difficult message forming tasks when the user may be concentrating on more important tasks.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for formulating and sending a message by a personal messaging device, comprising:
forming by user input a static component of a message template stored in the personal messaging device;
specifying by user input a dynamic component of the message template that includes a set of dynamic information obtained from a set of information sources at an occurrence of one or more dynamic events; and
specifying by user input a trigger condition that when satisfied causes one or more wireless messages to be transmitted using the message template.

2. The method according to claim 1, wherein specifying the set of dynamic information comprises specifying by user input the set of dynamic information, which is thereby identified in the message template.

3. The method according to claim 1, wherein the set of dynamic information includes at least one information type of a group of information types consisting of text, voice, graphics, picture, video, audio, texture, taste, smell, biometric, location, and orientation information.

4. The method according to claim 1, wherein specifying the set of dynamic information comprises specifying by user input the set of information sources, which are thereby identified in the message template.

5. The method according to claim 1, wherein the set of information sources comprises one or more information sources from a group of information sources consisting of a navigation system, a biometric system, a proximity detection system, an orientation determination system, and an environmental sensing system.

6. The method according to claim 1, wherein specifying by user input a dynamic component further comprises specifying by user input the one or more dynamic events, which are thereby identified in the message template.

7. The method according to claim 6, further comprising:
specifying a relationship involving at least one member of the set of dynamic information; and
determining an occurrence of a dynamic event when the at least one member satisfies the relationship.

8. The method according to claim 7, wherein the relationship is equality between one member of the set of dynamic information and a target value.

9. The method according to claim 1, wherein each of the one or more dynamic events is one of a button push, a sensed audio pattern, an orientation change, a sensor input, a proximity determination, a specified time, and a specified incoming message.

10. The method according to claim 1, further comprising equating the one or more dynamic events to instances of satisfaction of the trigger condition.

11. The method according to claim 10, further comprising:
specifying a relationship involving at least one member of the set of dynamic information; and
satisfying the trigger condition when the at least one member satisfies the relationship.

12. The method according to claim 11, wherein the relationship is equality of one member of the set of dynamic information and a target value.

13. The method according to claim 1, further comprising:
specifying a relationship involving at least one member of the set of dynamic information; and
satisfying the trigger condition when the at least one member satisfies the relationship.

14. The method according to claim 13, wherein the relationship is equality between one member of the set of dynamic information and a target value.

15. The method according to claim 1, wherein the trigger condition is one of a button push, a sensed audio pattern, an orientation change, a sensor input, a proximity determination, a specified time, and a specified incoming message.

16. The method according to claim 1, wherein the trigger condition occurs more than once.

17. Means for wireless communication, comprising:
means for forming by user input a static component of a message template stored in a personal messaging device;
means for specifying by user input a dynamic component of the message template that includes a set of dynamic information obtained from a set of information sources at an occurrence of one or more dynamic events; and
means for specifying by user input a trigger condition that when satisfied causes one or more wireless messages to be transmitted using the message template.

18. Means for wireless communications according to claim 17, further comprising:
means for transmitting a message using the message template upon occurrence of the trigger condition.

19. A personal messaging device, comprising:
user input and output functions;
a processing function, coupled to the user input and output functions, that can interact with a user of the personal messaging device to accept user input that
forms a static component of a message template stored in the personal messaging device,
specifies a dynamic component of the message template that includes a set of dynamic information obtained from a set of information sources at the occurrence of one or more dynamic events, and
specifies a trigger condition that when satisfied causes one or more wireless messages to be transmitted using the message template; and
a wireless transmitter that transmits the one or more wireless messages.
